(19) United States
(12) Patent Application Publication
(10) Pub. No.: US 2019/0230871 A1
(43) Pub. Date: Aug. 1, 2019

(54) SUPPORTING POLE FOR VINEYARDS

(71) Applicant: MOLLIFICIO BORTOLUSSI S.R.L., Fiume Veneto (IT)

(72) Inventors: Claudio BORTOLUSSI, Fiume Veneto (IT); Franco BORTOLUSSI, Fiume Veneto (IT)

(73) Assignee: Mollificio Bortolussi S.r.l., Fiume Veneto (IT)

(21) Appl. No.: 16/320,021

(22) PCT Filed: Aug. 23, 2017
(86) PCT No.: PCT/IB2017/055084

§ 371 Date: Jan. 23, 2019

(30) Foreign Application Priority Data
Aug. 31, 2016 (IT) 102016000088712

(51) Int. Cl. A01G 17/06; A01G 9/12

(52) U.S. Cl. CPC A01G 17/06; A01G 9/122

(57) ABSTRACT

Vineyard supporting pole, in particular an intermediate pole arranged between the two head poles, between which is stretched the plant carrying wire, the pole consisting of a metal section whose lower end is driven into the ground. The top end of the pole has a sliding surface for supporting the plant, the sliding surface being formed by a curved part of the metal section, which is furrowed by a groove within which the carrying wire is held.

### TECHNICAL FIELD OF INVENTION

The present invention is relative to a vineyard supporting pole, in particular an intermediate pole that is arranged between the two head poles, wherein is stretched the wire for holding up the growing plants.

### PRIOR ART

With the increasing farm mechanization, vineyards are subjected to more punishing treatments, carried out in particular with grape harvesting machines. These machines shake the branches with a certain force, and therefore the plants must be conveniently supported and trained in their natural growth.

In short, the layout of a vineyard includes two head poles that are anchored to the ground with cables or metal braces connected to buried plates of metal or cement; between the two head poles is stretched a wire, called carrying wire, which supports and guides the growing grapevines. Each grapevine is held up by a so-called tutor to which is tied the vine stalk.

Between the two head poles are also provided intermediate poles, arranged suitably spaced apart from each other, having the purpose of supporting and guiding the carrying wire along which will extend the branches and the canopies of the vines.

These intermediate poles normally consist of metal section, for example having a T or a C cross section, to which the carrying wire is fastened with ties made of pieces of wire. The branches and the canopies of the grapevines can coil around the the carrying wire and rest on the top end of the intermediate poles.

### TECHNICAL PROBLEM TO SOLVE

The prior art described above refers in particular to a grapevine layout referred to as free cordon, which has been studied with a view of the mechanized work carried out on the vineyard.

The most serious problem in a row of grapevines having this structure is found at the top ends of the intermediate poles, where the branches of the grapevine tend in time to develop a phenomenon defined as “embedment”. This phenomenon consists of a progressive embedding to a certain depth of the end of the pole into the wooden body of the branch, and is due to the fact that the end surface of the pole has a limited extent. Moreover, the end of the pole has a rough and irregular finish, as it is a metal section that does not require a specific finishing machining.

### SUMMARY OF THE INVENTION

The objective of the invention is achieved with a pole for supporting a vineyard, whose characteristics are essentially defined in independent claim 1 of the present patent. Further details are disclosed in the dependent sub claims.

Characteristics and advantages of the invention will become evident from the description which follows, by way of example without limitations, with reference to the enclosed drawings, wherein:

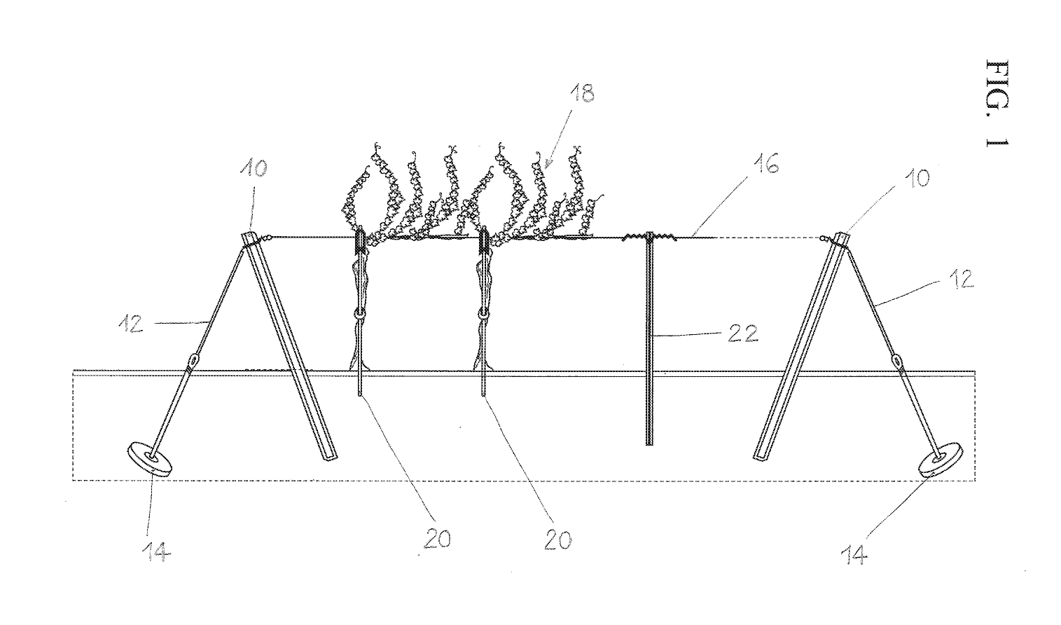

FIG. 1 illustrates schematically a row of grapevines in a vineyard;

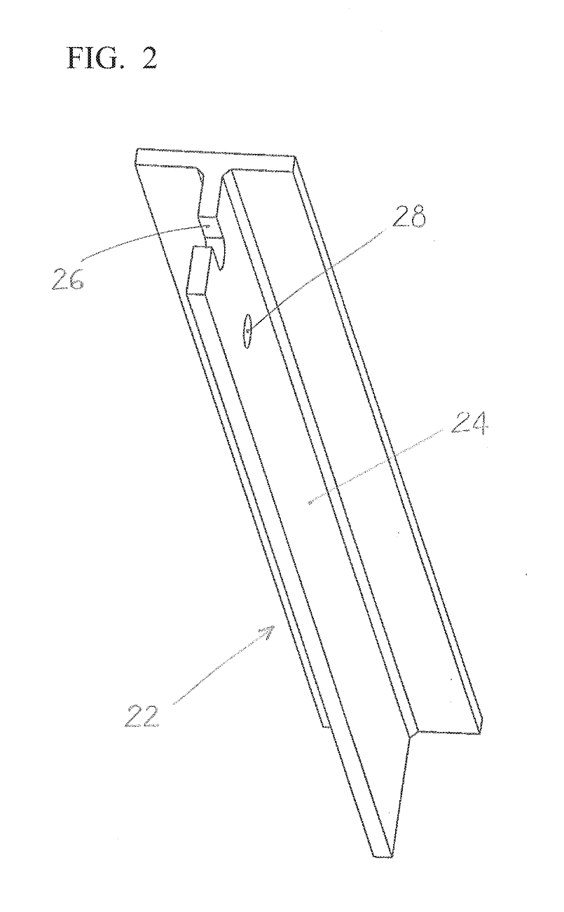

FIG. 2 illustrates, in a perspective view, an intermediate vineyard support pole of FIG. 1, according to the prior art;

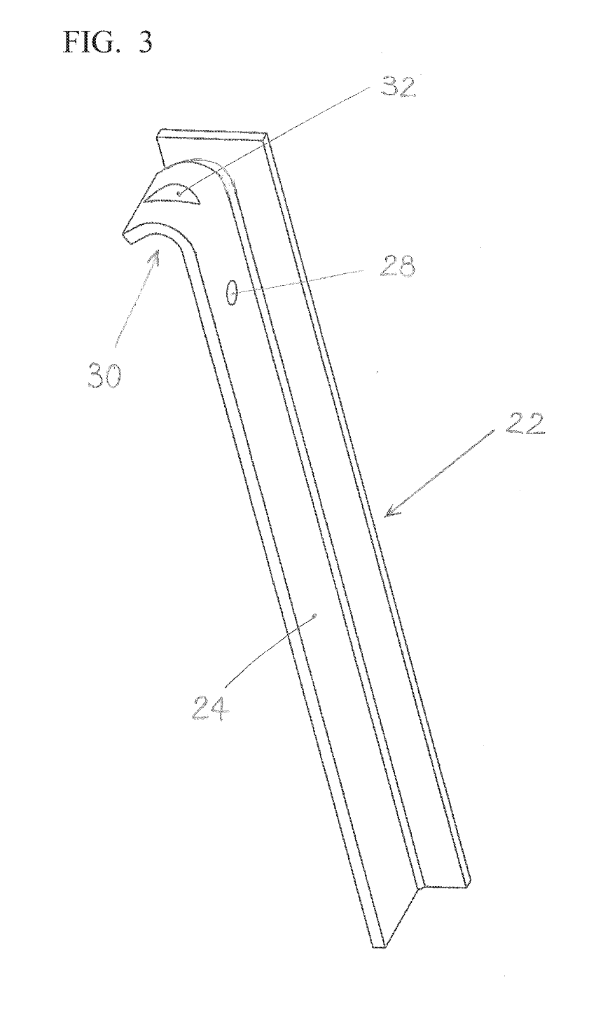

FIG. 3 illustrates, in a perspective view, an intermediate vineyard support pole of FIG. 1, according to the present invention;

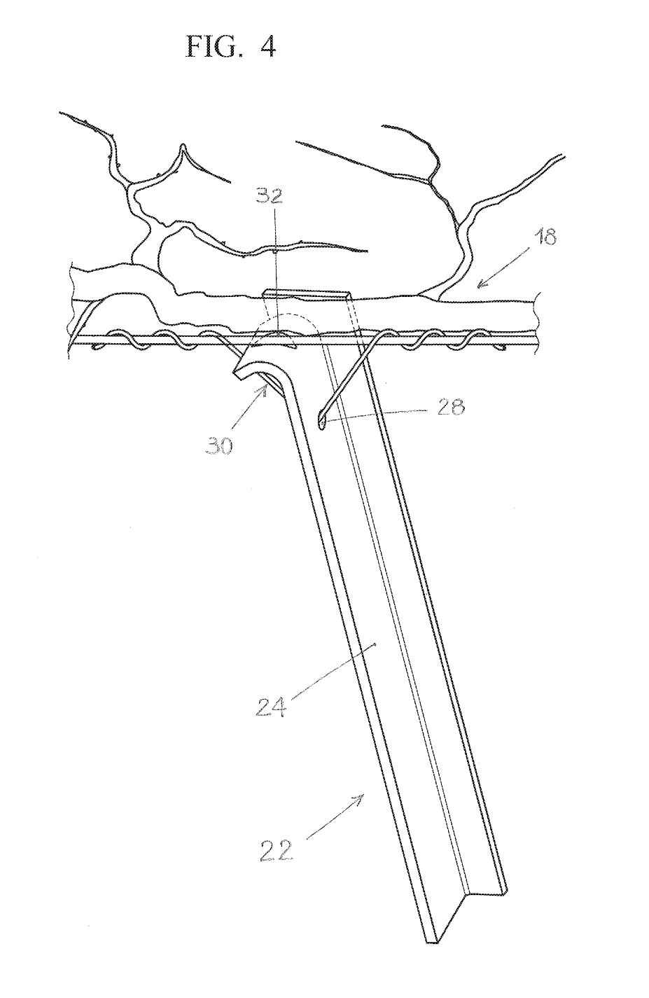

FIG. 4 illustrates, in partial cross section, a detail of the pole of FIG. 3, and

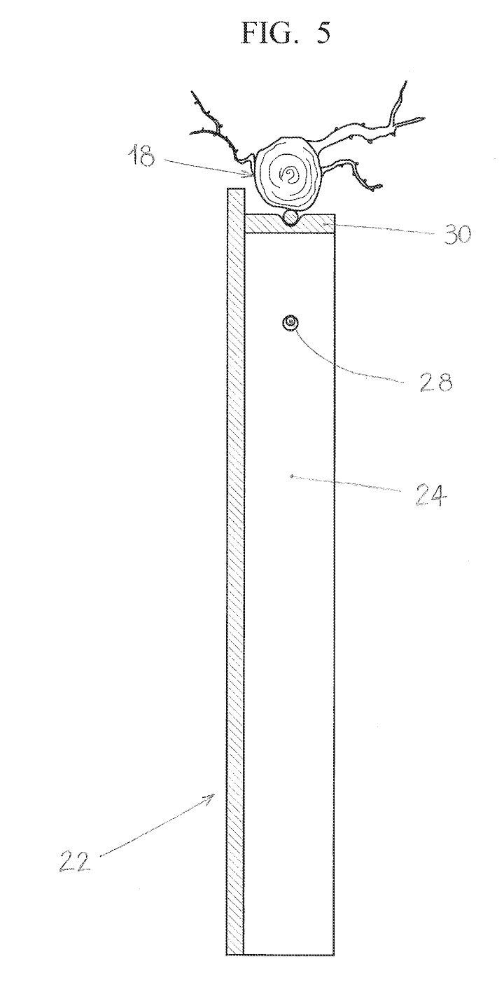

FIG. 5 illustrates, I a perspective view, the pole of FIG. 3, on which is supported a part of the plant.

### DETAILED DESCRIPTION OF THE INVENTION

FIG. 1 illustrates schematically a row of grapevines in a vineyard.

Substantially, the vine row consists of two head poles 10, that are anchored to the ground by means of cables, or metal braces, 12 connected to buried plates 14 made of metal or cement. Between the two head poles 10 is stretched a wire 16, referred to as carrying wire. The carrying wire 16 must hold up and guide the plants 18 during their growth. Each grapevine is supported by a tutor 20 to which the stalk of the vine.

Between the two head poles 10 are also provided a plurality of intermediate poles 22 (only one is shown in the figure), arranged suitably spaced apart, whose purpose is to hold up and guide the carrying wire 16, along which are trained the branches and the canopies of the grapevines.

The intermediate poles 22 are normally made with metal sections, for example with a T or C cross section, which are driven into the ground and to which the carrying wire 16 is normally fastened with ties consisting of pieces of wire.

As shown in FIG. 1, the branches of the grapevines can entwine around the carrying wire, and eventually they grow until they rest on the top end of the intermediate poles 22.

FIG. 2 illustrates, in a perspective view, an intermediate pole 22 for supporting the vineyard of FIG. 1, according to the prior art.

The intermediate pole 22, in the specific example, is a metal section with a T-shaped cross section, in which the wing 24 orthogonal in the direction of extension of the carrying wire 16 has its upper end provided with a notch 26 to hold and guide the carrying wire 16. Further, the wing 24 of the intermediate pole 22 is provided with a through hole 28 which holds the fastening member used to tie the carrying wire 16 to the intermediate pole 22. The through hole 28 is provided in a suitable position below the notch 26.

As already mentioned, the drawback of this type of pole lies in the fact that the grapevine on a traditional T-shaped pole tends to “embed”, that is, incorporate in its stalk the upper metal part of the support.

This situation occurs due to the following reasons:
The stable part (about 20 years) of the grapevine (horizontal stalk) is tied very firmly, being wound and entwined around the carrying wire, an important requirement to mechanize the various processes, like pruning, harvesting, etc.
The weight of the whole: stalk-vegetation-fruit (grapes).
Mechanical actions such as shaking, vibrations, etc., carried out during the various processes.
Very small cross section of the upper part of the intermediate support pole, which supports the whole at that height above the ground.

FIG. 3 illustrates, in perspective, an intermediate pole 22, according to the invention; numerical references corresponding to the ones of the prior-art pole are maintained in the description of the pole of the present invention.

In this case too, the pole 22 consists of a T-shaped metal section, but in this case the wing 24, which is orthogonal to the direction of extension of the carrying wire, has a curved upper end 30. In this manner, the upper end 30 presents to the growing branches of the vine a substantially smooth support surface that is much wider, thus avoiding the risk of the support becoming embedded in the wooden part of the plant.

To guarantee in any case the guide of the carrying wire 16, the surface of the upper end 30 of the pole 22 is still provided with a notch 32 aligned with the direction of extension of the carrying wire.

The wing 24 of the T-shaped section is also provided with a through hole 28 for engaging the member 34 for fastening the carrying wire to the intermediate pole 22.

FIG. 4 illustrates, in partial cross section, a detail of the intermediate pole 22 viewed in the direction of extension of the carrying wire 16.

As can be seen, thanks to its curvature, the upper end of the wing 24 is perfectly adapted to guide the carrying wire 16 by means of the notch 32, and also provides a surface that is effectively smooth for supporting the branches 18 of the grapevine.

FIG. 5 illustrates in a perspective view the pole of FIG. 3, on which is supported a part of the grapevine 18. The innovative solution thus appears as particularly simple and effective for solving the technical problem indicated above.

1. A pole for supporting a vineyard, wherein the pole is an intermediate pole arranged between two head poles to which a wire is stretched in order to holding up the plants, the intermediate pole being made by a metal section having its lower end driven into the ground,
wherein
the upper end of the intermediate pole has a sliding surface for bearing the plants, the sliding surface being furrowed by a groove within which the wire holding the plant is held.

2. The pole for supporting a vineyard according to claim 1, made by a T-shaped metal section, the upper end of one of its two wings being curved and forming the sliding surface for holding the plant.

3. The pole for supporting a vineyard according to claim 2, wherein the wing of the T-shaped metal section, which is provided with the curved upper end, is further provided with a through hole wherein a fastening member for the supporting wire is engaged with the pole.

4. The pole for supporting a vineyard according to claim 3, wherein the through hole in which the fastening member of the supporting wire is engaged, is accomplished at a position spaced lower as regards to the curved end of the wing of the T-shaped metal section.
